(19) United States
(12) Patent Application Publication
(10) Pub. No.: US 2020/0102875 A1
(43) Pub. Date: Apr. 2, 2020

(54) EXHAUST GAS PURIFICATION DEVICE

(71) Applicant: Jung-Tsung WEI, Tainan City (TW)

(72) Inventor: Jung-Tsung WEI, Tainan City (TW)

(21) Appl. No.: 16/353,093

(22) Filed: Mar. 14, 2019

(30) Foreign Application Priority Data
Sep. 28, 2018 (TW) 107134382

(51) Int. Cl. F01N 13/00; F01N 3/08; F02D 41/02; F01N 3/18

(52) U.S. Cl. CPC F01N 13/0097; F01N 3/0828; F01N 13/02; F01N 3/18; F02D 41/029

(57) ABSTRACT

An exhaust gas purification device includes an exhaust gas discharge unit having an exhaust gas passage, and a plurality of smoke purifying units. Each smoke purifying unit includes a smoke purifying module disposed outside of the exhaust gas discharge unit and including an elongated smoke purifying holder defining a channel, and at least one water spray pipe for spraying water into the channel. An exhaust gas capture module includes a first exhaust gas capture pipe communicating the exhaust gas passage with the channel and having a first smoke trap extending into the exhaust gas passage.

### CROSS-REFERENCE TO RELATED APPLICATION

This application claims priority to Taiwanese Patent Application No. 107134382, filed on Sep. 28, 2018.

### FIELD

The disclosure relates to a purification device, more particularly to an exhaust gas purification device which can reduce harmful substances in the exhaust gas or smoke.

### BACKGROUND

Generally, industrial sites, such as chemical plants, incineration plants, power plants, etc., often produce various exhaust gases during operation, and the contents of the exhaust gases may vary depending on the processing materials and the processing conditions. Generally speaking, exhaust gas often contains harmful substances, such as particulate contaminants, sulfur oxides, hydroxides, and the like. Early factories use chimneys to directly discharge exhaust gas into the sky.

In today's environmental awareness, most factories will install purification equipment to reduce the amount of harmful substances in the exhaust gas.

However, the equipment for purifying the exhaust gas is usually installed at the beginning of the plant construction and according to the requirement then.

When it is found that the purification effect of the exhaust gas purification equipment is not good, or breaks down after using it for a period of time, it is difficult to install a device for improving the quality of exhaust gas emission from the existing exhaust gas purification equipment or the chimney, or replace a new exhaust gas purification equipment. The way to improve often requires re-planning and rebuilding of the plant, and this not only causes increase in the cost and time of improvement, but also has an adverse effect on the time and cost of the plant operation.

### SUMMARY

Therefore, an object of the present disclosure is to provide an exhaust gas purification device that can alleviate at least one of the drawbacks of the prior art.

Accordingly, an exhaust gas purification device of this disclosure includes an exhaust gas discharge unit having an exhaust gas passage, and a plurality of smoke purifying units. Each smoke purifying unit includes a smoke purifying module disposed outside of the exhaust gas discharge unit, and an exhaust gas capture module. The smoke purifying module includes an elongated smoke purifying holder defining a channel, and at least one water spray pipe for spraying water into the channel. The exhaust gas capture module includes a first exhaust gas capture pipe communicating the exhaust gas passage with the channel and having a first smoke trap extending into the exhaust gas passage.

### BRIEF DESCRIPTION OF THE DRAWINGS

Other features and advantages of the disclosure will become apparent in the following detailed description of the embodiments with reference to the accompanying drawings, of which:

FIG. 1 is a top view of an exhaust gas purification device according to the first embodiment of this disclosure;

FIG. 2 is a fragmentary side sectional view of the first embodiment;

FIG. 3 is an enlarged sectional view of a smoke purifying module and a waste water recycling module of the first embodiment;

FIG. 4 is a fragmentary perspective view of an exhaust gas purification device according to the second embodiment of this disclosure; and

FIG. 5 is an enlarged fragmentary sectional view of the second embodiment.

### DETAILED DESCRIPTION

Before the present disclosure is described in greater detail with reference to the accompanying embodiments, it should be noted herein that like elements are denoted by the same reference numerals throughout the disclosure.

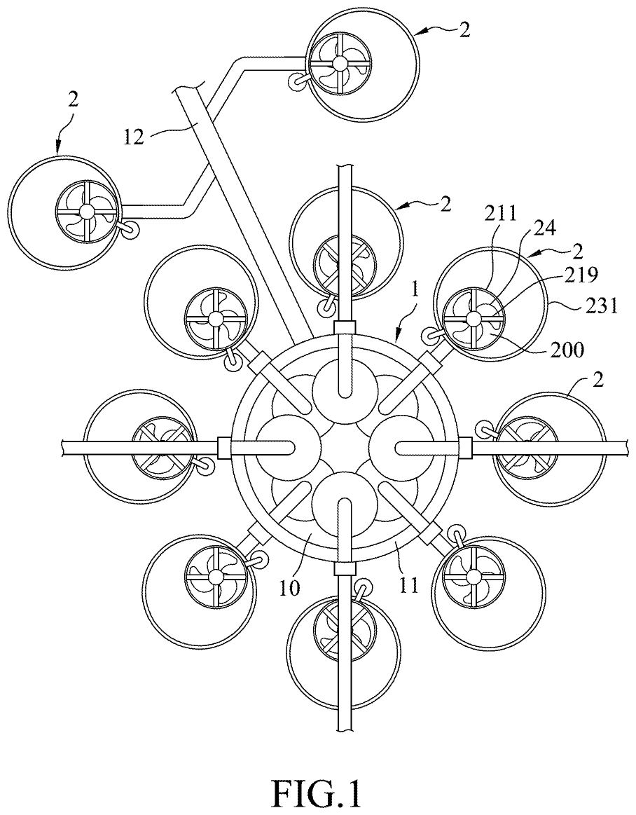

Referring to FIGS. 1 to 3, an exhaust gas purification device according to the first embodiment of the present disclosure is suitable for connection with an exhaust gas generating equipment (not shown) for purifying exhaust gas generated therefrom. The exhaust gas purification device of this embodiment comprises an exhaust gas discharge unit 1 and a plurality of smoke purifying units 2 for purifying exhaust gas generated by the exhaust gas generating equipment.

The exhaust gas discharge unit 1 includes an exhaust pipe 11 similar to a chimney, a smoke pipe 12 connected between the exhaust gas generating equipment and the exhaust pipe 11 for guiding the exhaust gas produced therefrom to the exhaust pipe 11, and an exhaust gas passage 10 cooperatively defined by the exhaust pipe 11 and the smoke pipe 12. The smoke pipe 12 is located in proximity to a bottom end of the exhaust pipe 11.

The smoke purifying units 2 can be selectively connected to one of the exhaust pipe 11 and the smoke pipe for purifying the exhaust gas passing through the exhaust gas passage 10. In this embodiment, some of the smoke purifying units 2 are connected to the exhaust pipe 11, while others of the smoke purifying units 2 are connected to the smoke pipe 12. Further, the smoke purifying units 2 connected to the exhaust pipe 11 are positioned at different heights of a rack (not shown). The smoke purifying units 2 in each height are angularly spaced apart from each other around the exhaust pipe 11. Since the structures of the smoke purifying units 2 are the same, only one of the smoke purifying units 2 which is connected to the exhaust pipe 11 will be described hereinafter.

The smoke purifying unit 2 includes a smoke purifying module 21 disposed outside of the exhaust pipe 11, an exhaust gas capture module 22 for conveying the captured exhaust gas to the smoke purifying module 21, and a waste water recycling module 23. The smoke purifying module 21 includes an elongated smoke purifying holder 211 defining a channel 210, a plurality of interconnected support pipes 212, and a plurality of water spray pipes 213. The support pipes 212 are disposed in the channel 210 to divide the channel 210 into a lower channel 216 and an upper channel 218. Each support pipe 212 defines a support pipe passage 215 extending along the length thereof and communicating with the lower and upper channels 216, 218. Each water spray pipe 213 extends into the support pipe passage 215 of a respective one of the support pipes 212, and has a plurality of spaced-apart water spray holes 214 arranged along the length thereof.

The exhaust gas capture module 22 includes a first exhaust gas capture pipe 221 that has one end extending into the exhaust passage 10 and that has the other opposite end extending out of the exhaust pipe 11 and connected to the smoke purifying holder 211 so as to communicate with the lower channel 216, and an air pump 222 connected to the first exhaust gas capture pipe 221 for conveying exhaust gas captured by the first exhaust gas capture pipe 221 to the lower channel 216. The first exhaust gas capture pipe 221 further has a first smoke trap 223 connected to the one end thereof and having a conical shape that tapers upwardly and inwardly.

There is no specific restriction on the shape and structure of the waste water recycling module 23, as long as it can recycle waste water. In this embodiment, the waste water recycling module 23 includes a waste water recycling tank 231 defining a chamber 230 that contains a predetermined amount of water and that receives and collects waste water flowing down from the channel 210, a water distribution tray 232 connected to the water spray pipes 213, a recycling pipe 233 connected between the chamber 230 and the water distribution tray 232, a water pump 234 connected to the recycling pipe 233 for conveying the water in the chamber 230 to the water distribution tray 233, and a water purifier 238 connected to the recycling pipe 233 for purifying waste water coming out of the chamber 230.

In this embodiment, the smoke purifying holder 211 is fixed to the waste water recycling tank 231 adjacent to the top thereof, and is located within the chamber 230. Further, the smoke purifying holder 211 has a bottom opening 217 communicating the lower channel 216 with the chamber 230, and a cross-shaped bar 219 fixed to and cooperating with a top end thereof to form a plurality of apertures 200 communicating the upper channel 218 with the outside environment. The waste water recycling tank 231 has an inclined wall 235 that is disposed below the channel 210 and that has an inner surface 236 facing the bottom opening 217. The smoke purifying module 21 further includes an exhaust fan 24 connected to the cross-shaped bar 219 for assisting discharge of the exhaust gas. However, the exhaust fan 24 is optional in this embodiment.

The smoke purifying unit 2 may further include a water temperature regulator 25 for regulating the temperature of water. In this embodiment, the water temperature regulator 25 is connected to the recycling pipe 233 for increasing the temperature of water entering the water spray pipes 213, but may be disposed on other places, as long as it can increase the temperature of the water.

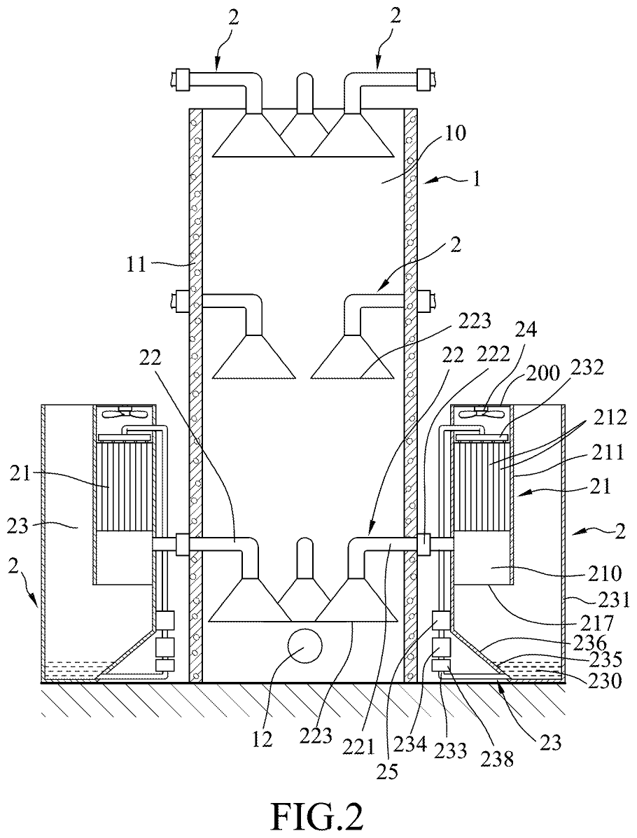

To achieve a better exhaust gas capturing effect, the first smoke traps 223 of the smoke purifying units 2 can be located at different heights of the exhaust pipe 11. As shown in FIG. 2, the first smoke traps 223 of some of the smoke purifying units 2 are located at a lower level of the exhaust pipe 11, the first smoke traps 223 of the other smoke purifying units 2 are disposed at a middle level of the exhaust pipe 11, and the first smoke traps 223 of the rest of the smoke purifying units 2 are disposed at an upper level of the exhaust pipe 11. Through the utilization of the first smoke traps 223 located at different heights of the exhaust pipe 11, exhaust gas flowing in different levels and heights of the exhaust pipe 11 can be captured. Since some of the smoke purifying units 2 are directly connected to the smoke pipe 12, the exhaust gas can be captured before it enters the exhaust pipe 11, so that the effect of capturing the exhaust gas can be enhanced.

To use the exhaust gas purification device of this embodiment, the smoke pipe 12 is first connected to the exhaust gas generating equipment. When the exhaust gas generated by the exhaust gas generating equipment passes through the smoke pipe 12, because the smoke pipe 12 is connected to some of the smoke purifying units 2, before the exhaust gas enters the exhaust pipe 11, a portion of the exhaust gas is already captured, so that only the remaining portion of the exhaust gas enters the exhaust pipe 11. Since the first smoke traps 223 of the smoke purifying units 2, which are connected to the exhaust pipe 11, not only extend into the exhaust passage 10, but also are disposed at different heights, most of the remaining exhaust gas are captured by the first smoke traps 223. Since each first exhaust gas capture pipe 221 is provided with the air pump 222, the exhaust gas captured by each first smoke trap 223 can quickly enter the channel 210.

When the exhaust gas captured by each first smoke trap 223 enters the lower channel 216 of the corresponding smoke purifying unit 2, it will flow up and enter the support pipe passages 215 of the support pipes 212. On the other hand, the water pump 234 of the waste water recycling module 23 of each smoke purifying unit 2 is operated to drive the liquid in the chamber 230 to flow toward the water distribution tray 232 through the recycling pipe 233. The liquid is distributed to the water spray pipes 213, and is sprayed into the support pipe passages 215 of the support pipes 212 through the water spray holes 214 for flushing the exhaust gas that enters the support pipe passages 215.

Since water is pressurized and ejected from the water spray holes 214 of each water spray pipe 213, columns of water will appear foggy and spray toward an inner surface of the corresponding support pipe 212. When the exhaust gas, such as particulate contaminants, harmful substances, etc., encounters the column of water, the exhaust gas will be flushed by the water. The water splashing on the inner surface 236 of the waste water recycling tank 231 will bounce and contact the exhaust gas again to increase contact among the water molecules and the exhaust gas, thereby promoting the effect of purifying the exhaust gas. Water containing harmful substances will flow down the chamber 230, while the purified air is discharged through the apertures 200 of each smoke purifying unit 2. Such a steady stream of operation can continuously filter the harmful substances in the exhaust gas, so that the purpose of improving the quality of exhaust gas emission can be achieved. In this embodiment, the water purifier 238 is connected to the waste water recycling module 23, so that the quality of the waste water is improved during the continuous operation. At the same time, the water temperature regulator can be used to change the temperature of the water (for example, adjusting the temperature to 70° C.). By changing the temperature of the water, the flushing effect can be enhanced, and the exhaust gas can be maintained to flow upward smoothly at high temperature at the same time.

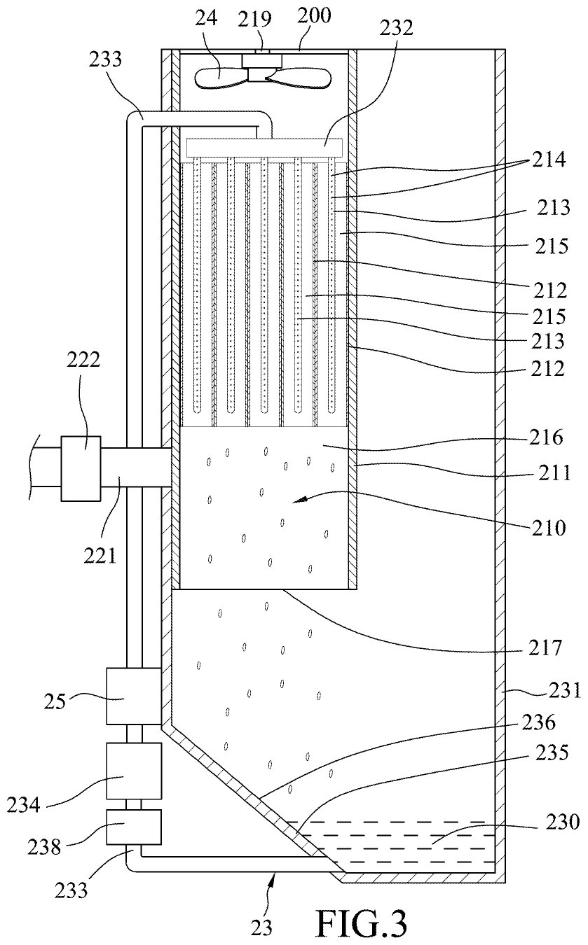

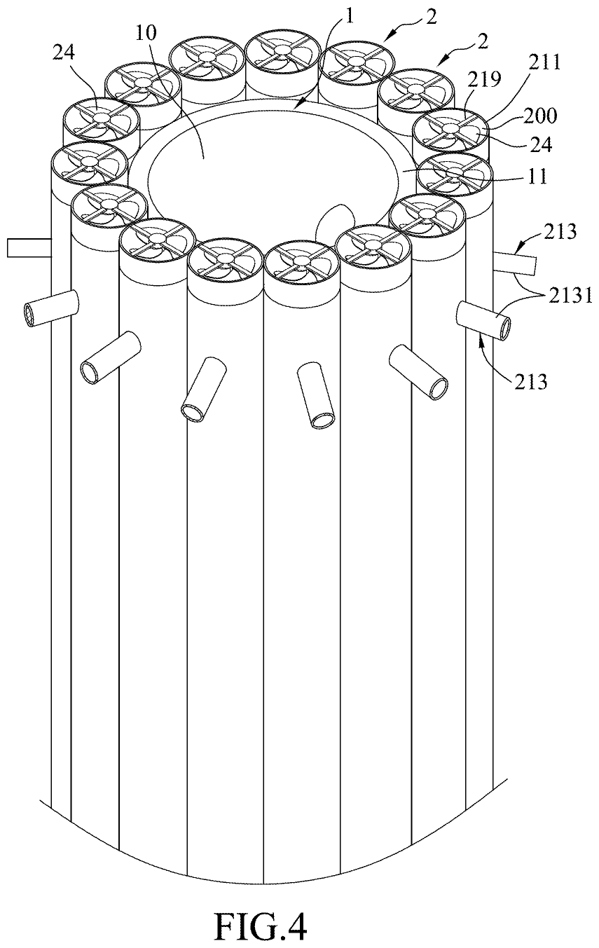

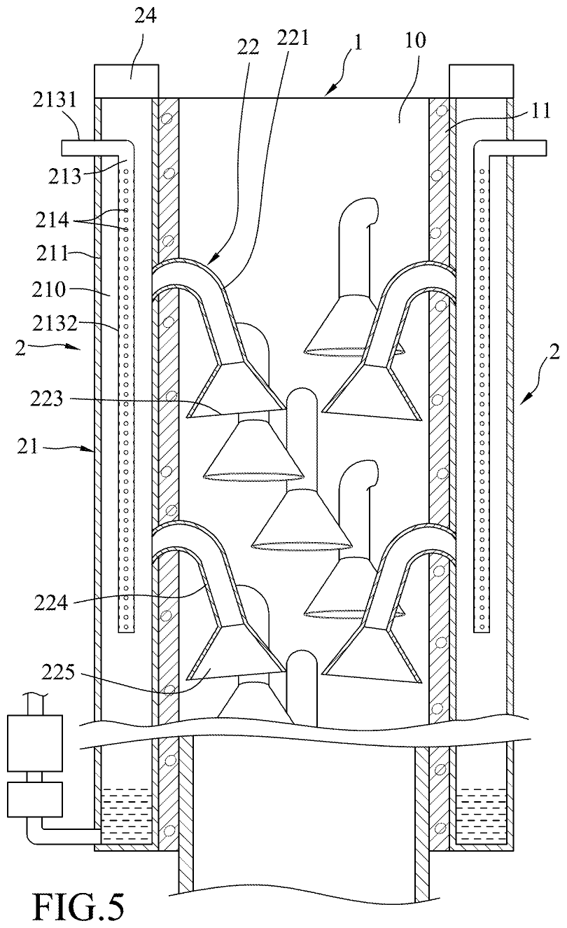

Referring to FIGS. 4 and 5, the second embodiment of the exhaust gas purification device according to this disclosure is substantially similar to the first embodiment. However, in this embodiment, the smoke purifying holders 211 of the smoke purifying units 2 closely surround the exhaust pipe 11, and the smoke purifying module 21 of each smoke purifying unit 2 includes only one water spray pipe 213. The water spray pipe 213 has an outer portion 2131 located outside of the smoke purifying holder 211, and an inner portion 2132 extending into the channel 210 and having the water spray holes 214 that communicate with the channel 210. The outer portion 2131 of the water spray pipe 213 may be connected to a water supply unit (not shown) or the recycling pipe 233 (see FIGS. 2 and 3) of the waste water recycling module 23 (see FIGS. 2 and 3) illustrated in the first embodiment.

The exhaust gas capture module 22 of this embodiment further includes a second exhaust gas capture pipe 224 disposed below the first exhaust gas capture pipe 221. That is, the first and second exhaust gas capture pipes 221, 224 are spaced apart from each other along the length of the exhaust pipe 11. The second exhaust gas capture pipe 224 has a second smoke trap 225. The first and second exhaust gas capture pipes 221, 224 are used for capturing the exhaust gas flowing through the exhaust passage 10 at different heights of the exhaust pipe 11, thereby increasing the amount of the exhaust gas captured.

In this embodiment, the waste water recycling module (not shown) may be provided on a bottom portion of the smoke purifying holder 211 for recycle and reuse of the waste water.

During use the exhaust gas purification device of the second embodiment, the first and the second exhaust gas capture pipes 221, 224 of each smoke purifying unit can capture the exhaust gas flowing through the exhaust gas passage 10, and convey the captured exhaust gas into the channel 210 of the smoke purifying holder 211. The water spray pipe 213 of each smoke purifying unit 2 can similarly be used to flush the exhaust gas flowing through the exhaust gas passage 10. Thus, the second embodiment can achieve the same effect as the first embodiment.

From the foregoing, it is apparent that the smoke purifying units 2 of the exhaust gas purification device of this disclosure can be disposed outside of the exhaust gas discharge unit 1 according to the use requirement without harming the original equipment. Further, the first and second smoke traps 223, 225 can extend into the exhaust gas passage 10 for capturing and conveying the exhaust gas to the smoke purifying units 2 for purification. The smoke purifying units 2 are suitable for mounting on the existing exhaust gas discharge unit 1. When one of the smoke purifying units 2 is out of order, it will not hinder the exhaust gas from being discharged upwardly, the other smoke purifying units 2 can still perform good smoke purifying effects. Further, because the first and second smoke traps 223, 225 of this disclosure will not hinder the exhaust gas from flowing upward from the bottom of the exhaust gas passage 10, even if the exhaust gas discharge unit 1 is out of order, discharging of the exhaust gas through the exhaust gas passage 10 will not be affected, so that work safety issues can be reduced. Hence, the exhaust gas purification device of this disclosure can achieve the effect of improving the quality of exhaust gas emission without changing the original equipment and can prevent work safety issues. Therefore, the exhaust gas purification device of this disclosure has a novel structure and an industrial utilization value.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An exhaust gas purification device comprising:
an exhaust gas discharge unit having an exhaust gas passage; and
a plurality of smoke purifying units, each of which includes a smoke purifying module disposed outside of said exhaust gas discharge unit, and an exhaust gas capture module, said smoke purifying module including an elongated smoke purifying holder defining a channel, and at least one water spray pipe for spraying water into said channel, said exhaust gas capture module including a first exhaust gas capture pipe communicating said exhaust gas passage with said channel and having a first smoke trap extending into said exhaust gas passage.

2. The exhaust gas purification device as claimed in claim 1, wherein said exhaust gas discharge unit includes an exhaust pipe and a smoke pipe cooperatively defining said exhaust gas passage, said smoke purifying units being connected to one of said exhaust pipe and said smoke pipe.

3. The exhaust gas purification device as claimed in claim 2, wherein said exhaust gas capture module further includes a second exhaust gas capture pipe that is spaced apart from said first exhaust gas capture pipe along the length of said exhaust pipe, that communicates said exhaust gas passage with said channel, and that has a second smoke trap extending into said exhaust gas passage.

4. The exhaust gas purification device as claimed in claim 1, wherein said smoke purifying module further includes a plurality of interconnected support pipes disposed in said channel and dividing said channel into a lower channel and an upper channel, each of said support pipes defining a support pipe passage communicating with said lower and upper channels, said smoke purifying module including a plurality of said water spray pipes, each of said water spray pipes extending into said support pipe passage of a respective one of said support pipes.

5. The exhaust gas purification device as claimed in claim 4, wherein each of said smoke purifying units further includes a waste water recycling module, said waste water recycling module including a waste water recycling tank defining a chamber that contains a predetermined amount of water and that receives and collects waste water flowing down from said channel, a water distribution tray connected to said water spray pipes, a recycling pipe connected between said chamber and said water distribution tray, a water pump for conveying the water in said chamber to said water spray pipes through said water distribution tray, and a water purifier connected to said recycling pipe for purifying waste water coming out of said chamber, said smoke purifying holder having a bottom opening communicating said lower channel with said chamber.

6. The exhaust gas purification device as claimed in claim 5, wherein said waste water recycling tank has an inclined wall having an inner surface facing said channel.

7. The exhaust gas purification device as claimed in claim 1, wherein said smoke purifying holder has a cross-shaped bar fixed to and cooperating with a top end of said smoke purifying holder to form a plurality of apertures communicating said channel with the outside environment, each of said smoke purifying units further including an exhaust fan connected to said cross-shaped bar.

8. The exhaust gas purification device as claimed in claim 1, wherein said exhaust gas capture module further includes an air pump connected to said first exhaust gas capture pipe for conveying exhaust gas captured by said first exhaust gas capture pipe to said channel.

9. The exhaust gas purification device as claimed in claim 2, wherein said first smoke traps of said first exhaust gas capture pipes of said exhaust gas capture modules of said smoke purifying units are located at different heights of said exhaust pipe.

10. The exhaust gas purification device as claimed in claim 1, wherein each of said smoke purifying units further includes a water temperature regulator for increasing the temperature of the water.
